(19) United States
(12) Patent Application Publication
(10) Pub. No.: US 2023/0192442 A1
(43) Pub. Date: Jun. 22, 2023

(54) METHOD FOR OPERATING AN ELEVATOR SYSTEM, AND SYSTEM FOR OPERATING ELEVATOR INSTALLATION

(71) Applicant: Inventio AG, Hergiswil (CH)

(72) Inventors: Tzvetan Horozov, Cham (CH); Axel Hosemann, Auw (CH)

(21) Appl. No.: 17/998,504

(22) PCT Filed: May 18, 2021
(86) PCT No.: PCT/EP2021/063071

§ 371 Date: Nov. 11, 2022

(30) Foreign Application Priority Data
May 18, 2020 (EP) 20175136.9

(51) Int. Cl. B66B 1/46

(52) U.S. Cl. CPC B66B 1/468; B66B 2201/4615; B66B 2201/4653; B66B 2201/4676

(57) ABSTRACT

A method for operating an elevator system includes a trusted device that creates an authentication data packet having a unique, periodically changing code based on the current time. A mobile device sends a mobile request message to a server including the request for the operation of the elevator system and the authentication data packet. A server verifies the authenticity of the mobile request message based on the authentication data packet included in the mobile request message and, after the authentication data packet has been verified, sends an instruction message to the elevator controller.

### FIELD

The present invention relates to a method for operating an elevator system, a system for operating an elevator installation, and the use of a trusted device according to a method for operating an elevator system.

### BACKGROUND

Known elevator installations typically comprise operating panels, which require passengers to operate the elevator installation by calling the elevator car from the landing operating panel (LOP), and then select a desired destination floor on the car operating panel (COP). Both operating panels require the physical presence of the user to allow the operation of the elevator installation, usually by necessitating the push of a button.

An advanced method and system for operating an elevator installation via the use of a mobile radio, such as a smartphone with an app installed thereon, is known from WO2015121294A1. In this system, the user is, via the app, presented with information about the nearby elevator landing and possible destinations thereof, and can select the target floor from outside the car. This method provides several advantages to the user when operating the elevator system, and can improve the travel comfort of the passenger.

The cited system utilizes an internet connection between the mobile radio and a server to transmit the user request. Since such a request is not bound to a physical location, a low-range identification code is transmitted within a limited range of the elevator landing to be received by the mobile radio and forwarded to the server when submitting the request. The identification code is then verified by the server. This way, a valid request can only be made when the mobile device has received a valid identification code and thus can be assumed to be in physical vicinity to the elevator installation, thereby simulating a physical LOP being activated by a user.

The identification code secures the system against denial of service attacks from remote attackers that do not know the identification code. The cited system, however, is not protected against replay attacks, which might ultimately lead to denial of service attacks, wherein an attacker might record one or more authentication codes and replay the codes at a later time from a remote location. Consequently, there is a need to harden the security of an elevator installation, such as the one described above, against such attacks.

### SUMMARY

The need is solved by the features described in the following, in particular the subject matter of the beneficial embodiments disclosed in the descriptions and the drawings.

According to a first aspect, the need is solved by a method for operating an elevator system, the elevator system comprising an elevator controller and a fixedly installed trusted device. The method comprises that the trusted device creates an authentication data packet, the authentication data packet comprising a unique, periodically changing code based on an element of a predefined sequence of numbers, and the trusted device makes the authentication data packet available. The method further comprises that the mobile device receives the authentication data packet, the mobile device obtains a request for the operation of the elevator system, the mobile device sends a mobile request message to a server, wherein the mobile request message comprises the request for the operation of the elevator system, and request authentication data. The request authentication data is one of the authentication data packet itself or an authentication token received from the server after having sent the authentication data packet to the server and the server has verified the authentication data packet. The method further comprises that the server verifies the authenticity of the mobile request message based on the request authentication data included in the mobile request message, and that the server, after the authentication data packet has been verified, sends an instruction message to the elevator controller, wherein the instruction message comprises an instruction to operate the elevator system according to the request for the operation of the elevator system.

According to a second aspect, the need is solved by a system for operating an elevator installation, the system comprising an elevator controller, a fixedly installed trusted device, at least one mobile device and a server. The trusted device is configured to periodically create at least one authentication data packet, the at least one authentication data packet comprising a unique, periodically changing code based on an element of a predefined sequence of numbers, wherein the most recently created authentication data packet of the at least one authentication data packet is a current authentication data packet. The trusted device is configured to periodically make the current authentication data packet available to be received by at least one mobile device, the at least one mobile device being configured to receive the current authentication data packet, and wherein the at least one mobile device, after having received the current authentication data packet, is a current mobile device, wherein the current mobile device of the at least one mobile device is configured to send a mobile request message to the server after having received a request for the operation of the elevator installation, wherein the mobile request message comprises the request for the operation of the elevator installation and request authentication data, wherein the request authentication data is one of the current authentication data packet itself or an authentication token received from the server after having sent the current authentication data packet to the server and the server has verified the authentication data packet. The server is configured to receive at least one mobile request message from the current mobile device of the at least one mobile device, the server is configured to verify the at least one mobile request message based on the request authentication data included in the mobile request message, and the server, after the at least one mobile request message has been verified, is configured to send an instruction message to the elevator controller, wherein the instruction message comprises an instruction to operate the elevator installation according to the request for the operation of the elevator installation.

In the following, different embodiments of the invention will be discussed. The embodiments are not to be understood as restricting the invention. Rather, enhancements and modifications are entirely possible within the scope of the present disclosure, particularly such which, for example, are inferable by the expert with respect to fulfillment of the need through combination or modification of individual features or method steps described in connection with the general or specific part of the description as well as present in the drawings and which through combinable features lead to a new subject or to new method steps or method step sequences.

### Components of the System

According to an embodiment, the elevator system or elevator installation (herein also described as elevator) can comprise an elevator controller, a fixedly installed trusted device, at least one mobile device and/or a server.

The elevator controller can be a device configured for controlling the function of the elevator, particularly for controlling aspects relating to the standard operation of the elevator, such as opening and closing of doors or transporting the car between floors. The elevator controller can be a physical unit, preferably installed close to the elevator system, for example in the machine room of the elevator. The elevator controller can comprise several physical subunits, or be implemented as software in one or more physical units or subunits.

The elevator controller can further be configured for receiving instruction messages from the server, wherein the instruction messages preferably include instructions for the operation of the elevator system, and wherein the elevator controller can control the elevator according to the instruction messages. For this, the elevator controller can comprise an interface, the interface being, for instance, a network interface such as an interface providing a cable-based ethernet connection, or a wireless modem. The interface can provide a connection to an information exchange infrastructure, such as a local area network or a wide area network, e.g. the internet.

The server can be configured for receiving instruction messages from the mobile device. Additionally, the server can be configured for sending instruction messages to the elevator controller. For this, the server can comprise an interface, the interface being, for instance, a network interface such as a cable-based ethernet connection or a wireless modem. The server can be connected to the same infrastructure as the elevator controller, or use different types or layers of information exchange infrastructure to transmit one or more instruction messages to the elevator controller. The server can be a physical server at any chosen location or a virtual server, such as a cloud server.

The mobile device can be configured for sending mobile requests to the server. The mobile device can be connected to the same information exchange infrastructure as the server, or use different types or layers of information exchange infrastructure to transmit one or more mobile requests. In one example, the mobile device is a personal mobile device such as a smartphone or smartwatch.

Furthermore, the mobile device can have one or more additional interfaces for receiving information. The interface can be a receiver. The additional interface can be configured for receiving the authentication data packet which was made available by the trusted device. The additional interface can be the same interface used to connect the mobile device to the information exchange infrastructure, e.g. a wireless local area network interface. The additional interface can further be a different type of interface than the interface connecting the mobile device to the information exchange infrastructure, for instance an optical interface, e.g. a camera, infrared wireless receiver or a barcode scanner, configured for reading or receiving an optical representation of the authentication data packet, e.g. a QR-code, a barcode, an alphanumerical string, a color pattern, an infra-red wireless transmission or such.

The additional interface can be an audio interface, audio-mechanical or mechanical interface, e.g. a microphone or a vibration sensor, configured for reading or receiving a representation of the authentication data packet encoded by a sequence of physically measurable signals, such as sounds, vibrations or noises, e.g. a melody, an ultrasonic signal or signal burst, one or more specific multitone notes or comparable signals, which do not need to be limited to the audible sound spectrum and do not need to be limited to air as a transfer medium.

The additional interface can be a radio frequency receiver, configured for receiving the authentication data packet when the authentication data packet is transmitted by the trusted device, preferably by using a known transmission protocol. In a preferred embodiment, the additional interface can be a wireless receiver for receiving short-range wireless signals, for instance a Bluetooth receiver, however, other suitable communication standards such as ANT+, IEEE 802.15.4, IEEE 802.22, ISM-band implementations, NFC, RFID, 6LoWPAN, and many others are known alternatives, for which the mobile device can comprise a receiver.

For example, in case RFID and/or NFC is used, the trusted device can be a passive device, i.e. it might have no power supply. The energy for operating the trusted device can be received from the mobile device.

The mobile device can be any mobile device, such as a device carried by a potential user of the elevator. The use of the elevator is typically transient, and the elevator can be configured to be used by multiple users. Consequently, the mobile device can be a transient mobile device. The mobile device can be specifically configured for interacting, directly or indirectly, with the elevator controller, the trusted device or the server. In a preferable example, the mobile device can, e.g. by utilizing common, universal standards, protocols or interfaces, be adapted for the use in the context of the elevator installation and method for operating the elevator installation without requiring modifications to the hardware of the mobile device. In another embodiment, the mobile device can be configured for the use in the described context by having an app installed thereon, the app preferably being configured for providing the functionality described in detail below. In another embodiment, the mobile device can use a standard application installed thereon such as a web browser. Further details are described in detail below.

Multiple mobile devices can be used, alone or together, with an elevator or server, or a number of elevators or servers, at the same time or at different times.

The fixedly installed trusted device, herein also referred to as trusted device, can be installed in the vicinity of an elevator landing, preferably in an area close to the landing-side door. The trusted device can be a single physical unit, or an assembly of subunits, wherein the subunits can be separated such that, for instance, one subunit is installed at a remote location, such as the elevator machine room, and another subunit is installed in the vicinity of the elevator landing. The trusted device can be, fully or in part, implemented in the form of software. The trusted device can be, fully or in part, combined with the elevator controller or other components of the elevator. The trusted device can be one of several trusted devices of the elevator, for example, several or all floors that are served by the elevator can have one or more trusted devices installed in the vicinity of the elevator landing or landings of the relevant floor.

The trusted device can preferably be installed such that it cannot be accessed during normal operation of the elevator, preferably such that the trusted device cannot be removed, vandalized, destroyed or tampered with, e.g. behind a closed access panel or on the inside of the elevator shaft.

The trusted device can be configured to make the authentication data packet available, in particular to make the authentication data packet available to the mobile device, in particular to make the authentication data packet available only within a limited range around the elevator landing. The limited range can be a range of up to 100 meters, and preferably around 20 meters. The range also depends of the technology for making the authentication data packet available. For example and in case NFC is used for transmitting the authentication data packet, the range might be only up to several centimeters. The range can be influenced, e.g. reduced or increased (e.g. via obstruction, absorption, reflection or interference), by obstacles such as walls or ceilings; the skilled person is aware of such effects and can adapt the trusted device so that it accounts for such influences.

According to an embodiment, the sequence of numbers is a monotonic sequence of numbers, in particular a strict monotonic sequence (adjacent numbers are not equal). For example, the time could be regarded as a monotonic sequence of numbers. For generating a number representation of the time, the current date, the hour and the minute could be used. During the same minute, several elements of the sequence would have the same value.

According to another embodiment, the sequence of numbers is generated by a counter. The counter might be increased by 1 or any other number for creating the next element in the sequence of numbers. The counter might be increased each time the trusted device creates a new unique, periodically changing code. The creation of the new unique, periodically changing code might be triggered by reading the code with the mobile device. The mobile device might use near field communication technology for reading the code.

The trusted device can make the authentication data packet available such that it can be received by the mobile device as described above in relation to ways for receiving the authentication data packet. In particular, the trusted device can comprise an element for displaying the authentication data packet in the form of a QR-code or a similar code, e.g. on a display.

In a preferred embodiment, the trusted device can comprise a low-power radio frequency transmitter. In some embodiments, instead of a low-power radio frequency transmitter, an ultrasonic transmitter can be used with comparable characteristics. The low-power radio frequency transmitter can be configured to repeatedly transmit a radio signal comprising the authentication data packet. The time between the subsequent transmission of the radio signals comprising the authentication data packets might also vary.

The low-power radio frequency transmitter typically transmits the authentication data packet regardless of the presence of a mobile device. In one example, a pairing between the mobile device and the low-power radio frequency transmitter is not required for the mobile device to receive the authentication data packet. In another example, no authentication of the mobile device is required for the mobile device to receive the repeatedly transmitted authentication data packet.

In a preferred embodiment, the elevator system comprises several trusted devices, or one trusted device comprising a multitude of low-power radio transmitters, displays or similar methods, for making available authentication data packet specific for landings or floors of the elevator system. In this configuration, each authentication data packet can preferably correspond to a specific landing or floor of the elevator.

### Authentication data packet transfer

As also described above, in a preferred embodiment, the trusted device repeatedly transmits an authentication data packet by using the Bluetooth-protocol, preferably in the form of an unpaired or unidirectional Bluetooth-transmission. The trusted device can function as a Bluetooth low energy beacon. The trusted device can also comprise a display element for displaying a representation of the authentication data packet, e.g. a QR-code. The trusted device can also repeatedly emit ultrasonic beacons comprising the authentication data packed encoded therein.

In another preferred embodiment, other technology is used for transmitting the authentication data packet from the trusted device to the mobile device, such as near-field communication or RFID.

The authentication data packet can be received by the mobile device when it is in communication range of the trusted device. The communication range depends on the communication technology used by the trusted device. The mobile device can be configured, for example via an app installed thereon, to utilize the built-in Bluetooth-receiver, the built-in camera, the built-in microphone or any other suitable receiver for receiving the authentication data packet. The app can further display selection options for the user to make a request for the operation of the elevator, e.g. for selecting a target floor. The mobile device can be connected to the internet via a built-in interface, e.g. a WLAN interface, or via a mobile cellular network such as GSM, UMTS, 5G or others.

The mobile device can, after the user has made a selection for the operation of the elevator, transmit the request for the operation of the elevator together with the authentication data packet, in the form of a mobile request message.

The authentication data packet included in the mobile request message can be the original authentication data packet, or a function can be performed on the authentication data packet by the mobile device, e.g. a compression function, an encoding function, a checksum calculation, symmetric or asymmetric encryption or any other similar function. In a preferred embodiment, the authentication data packet can be fully restored by the server, i.e. the function performed by the mobile device is reversible. In another embodiments the mobile device can perform a function which is irreversible, such as a hashing function or a cryptographic function.

The mobile device can be configured to receive multiple authentication data packets and perform a selection of the authentication data packet to be included in the mobile request message when the mobile request message shall be sent, e.g. when the user makes the selection for the operation of the elevator. The mobile device can store several authentication data packets, e.g. by storing data packets in a buffer, such as the data packets received within the last 30 seconds. In one example, the mobile device stores metadata about the data packets, such as signal strength, signal to noise ratio or the time of receival, and in a preferred embodiment, selects the authentication data packet with the highest signal strength that has been received within a permissible time, e.g. the last 10 seconds, and has a signal to noise ratio higher than an arbitrary threshold, e.g. 20 dB. This can allow the mobile device to select the authentication data packet transmitted by the closest trusted device, even when multiple trusted devices are in range, e.g. when several elevators are present on a single floor.

The mobile device can transmit the mobile request message via a communications network such as the internet, preferably to be received by the server. The transmission of the data packet can have a unidirectional nature, i.e. there is no requirement for the server to establish a bidirectional connection with the mobile device, such as that required for an authentication handshake between the mobile device and the server.

It is possible for the communication between the mobile device and the server to be performed via an inherently bidirectional protocol, such as TCP or protocols based on TCP, however, the skilled artisan understands that low-level communication, such as the acknowledgement of packet receipt sent by the server, does not constitute a bidirectional communication in this context. Furthermore, the unidirectional nature of the described method or system does not preclude other communication between the server and the mobile device for unrelated purposes.

Not requiring a server response in the context of operating the elevator is a beneficial result of the solution to the object provided herein.

The server, after having received a mobile request message, can be configured to verify the mobile request message, based on the authentication data packet. For this, the authentication data packet included in the mobile request message can be analyzed according to the authentication and verification procedure described below. In a preferred embodiment, the analyzation results in the server allowing requests that are valid, and rejecting requests that are invalid. In another preferred embodiment, the authentication data packet comprises information about the time of creation of the authentication data packet, and the server can analyze the authentication data packet such that it can obtain information about the time of creation of the authentication data packet. In a preferred embodiment, the server can reject requests for the operation of the elevator system based on the age of the authentication data packet included in the mobile request message.

The server can further be configured to forward the request for the operation of the elevator system as included in the mobile request message. In a preferred embodiment, the request for the operation of the elevator system is forwarded as an instruction message. The server can forward the instruction message to the elevator controller. The server can forward the instruction message via one or more intermediate modules, nodes, computers or controllers, which can forward the instruction message directly, or store the instruction message for a period of time, or modify the instruction message before sending it. The connection between the server and the elevator controller can be an internet connection, preferably a secure connection.

According to an embodiment and as an alternative to sending the authentication data packet with the mobile request message to the server, the mobile device sends the authentication data packet to the server, typically just after having it received from the trusted device. The server, after having received the authentication data packet, can be configured to verify the authentication data packet. For this, the authentication data packet can be analyzed according to the authentication and verification procedure described below. In case the server has successfully verified the authentication data packet an authentication token is sent back to the mobile device. The authentication token can be sent as part of the request authentication data for the purpose of verifying the request message.

### Authentication Data Packet Creation and Verification

In one embodiment, the authentication data packet is created such that it comprises a unique, periodically changing code based on an element of a predefined sequence of numbers. In this embodiment, the sequence of numbers is the time and the element is the current time. Other embodiments are also possible as described. The code can be unique such that the code exclusively can be attributed to a single trusted device by which it was created, e.g. the code can comprise information from which can be derived or verified that the code was created by a specific trusted device. The code can include a unique identifier of the trusted device, or can be encoded such that the encoding can be uniquely identified. To achieve this uniqueness, several possible methods for encoding, encrypting or signing the code are known to the skilled person.

The code can further be periodically changing. The code can include information relating to the current time at which the code was created. The periodical change can be performed at variable intervals, wherein the intervals can be random. The periodical change can also be related to the passing of time, e.g. wherein the periodicity reflects the passing of a certain time interval. The periodical change of the code can be based on the current time. The code can change in relation to a preset expiration period, such that every code is valid for a predefined epoch, wherein the code change reflects the end of a previous epoch.

The code can also periodically change such that the change does not directly relate to the passing of time, e.g. in a random interval, but such that the code includes information about the current time, in which case it can be understood that the code is based on the current time, whereas the periodical change is not based on the current time.

In one embodiment, the server can verify the authentication data packet by verifying the code comprised within the authentication data packet, by performing a cryptographic function related to the method for encoding, encrypting or signing as described above, or a corresponding function thereof.

The function can provide information about the current time encoded or stored within the code, and the function can provide information about the identity of the trusted device that created the code. The server can, by applying the function to the code, directly or indirectly, identify the trusted device that created the code, and identify the time at which the code was created, or time period in which the code was created.

The server can reject authentication data packets comprising invalid codes. The server can identify if the code has been corrupted or created by a device that is not a trusted device. The server can further identify if the code was created before a past expiration date, and reject authentication data packets that are too old.

Various methods for creating and verifying authentication data packets are presented in detail below.

The following general aspects relate to further embodiments for the solutions of the need:

According to an aspect, the server comprises a list of keys, and the list of keys comprises a key corresponding to an authentication key of the trusted device.

According to an aspect, the authentication signature is created by the trusted device of the elevator system, and the authentication signature is created with a private authentication key stored within the trusted device of the elevator system.

According to an aspect, the server comprises a list of public keys, and the list of public keys comprises a public key corresponding to the private authentication key of the trusted device.

According to an aspect, the server is configured to reject the request for the operation of the elevator system when the timestamp, optionally in combination with the expiration indicator, indicates that the authentication data packet has expired.

According to an aspect, the mobile device stores metadata about the received authentication data packets, wherein the metadata about the authentication data packets comprises one or more of the following: the time a respective authentication data packet was received, the signal strength of the respective data packet transmission, the number of trusted devices from which authentication data packets were received within a time period, and transmission data such as the channel, band or frequency on which the respective authentication data packet was transmitted.

According to an aspect, the request for the operation of the elevator system is a user request.

According to an aspect, the request for the operation of the elevator system is a request not generated by a user, preferably an automatically generated request.

### DESCRIPTION OF THE DRAWINGS

FIG. 1 System for operating an elevator installation.

FIG. 2 Method for creating and verifying an authentication data packet.

FIG. 3 Alternative method for creating and verifying an authentication data packet.

FIG. 4 Alternative methods for creating and verifying an authentication data packet.

FIG. 5 Variation of the elevator system shown in FIG. 1.

### DETAILED DESCRIPTION

The details of one or more implementations of the subject matter described in this specification are set forth in the accompanying drawings and the description below. Other potential features, aspects, and advantages will become apparent from the description, and the drawings.

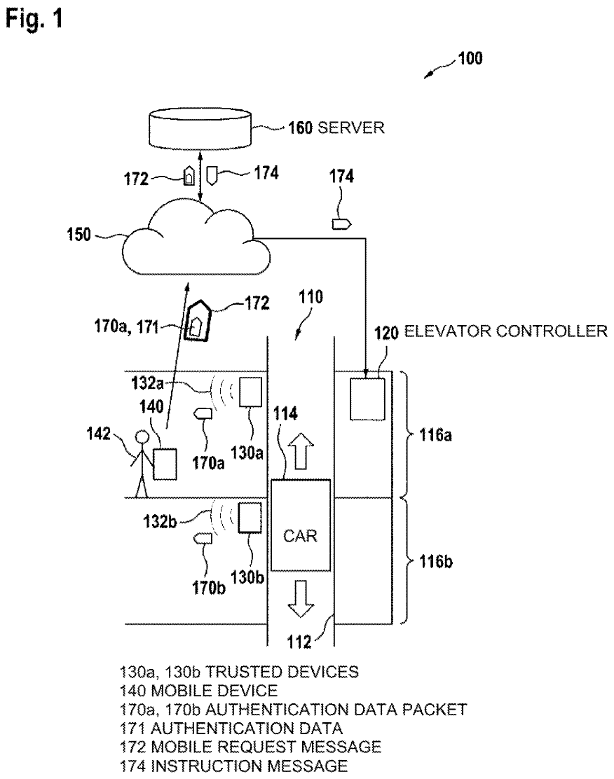

The embodiment of FIG. 1 describes an elevator system 100 which is suitable for executing the method for operating an elevator installation as described herein. Other known elevator systems might be suitable for executing the method for operating an elevator installation, such as the one known from WO2015121294A1, on which the elevator system of FIG. 1 is based, provided that the components of the elevator system are configured accordingly.

The elevator system 100 comprises an elevator installation 110 with an elevator shaft 112, a car 114 movably installed within the elevator shaft, and several floors 116a, 116b between which the elevator car can move, in order to transport passengers between the floors 116a, 116b. The elevator installation can further comprise additional components of the elevator system 100.

The system further comprises an elevator controller 120. The elevator controller controls the elevator, such as the travel of the car 114 between floors 116a, 116b.

The elevator system further comprises trusted devices 130a, 130b. The trusted devices periodically create an authentication data packet 170a, 170b and periodically make the authentication data packet 170a, 170b available to be received by a mobile device 140.

The authentication data packet typically periodically changes with an interval of 0.01 s to 24 hours, e.g. with an interval of 1 s to 60 minutes, or 1 s to 60 s. The authentication data packet typically comprises a unique, periodically changing code based on the current time. Instead of using the time also any other suitable predefined sequence of numbers could be used instead of the time. Examples are described below in details; possible sequences are for example natural numbers, which are simple to handle and/or calculate. But any other sequence would be possible as well, which however might be more difficult to handle. Properties of the authentication data packet that are related to the time such as the expiration indicator or the time period, in which the authentication data packet is valid must be adapted as well to the chosen sequence of numbers. The code can be a cryptographically digested code, or a cryptographically protected code. The authentication data packet typically comprises an expiration indicator, which represents a timespan after which, or a time by which the authentication data packet becomes invalid.

In the embodiment of FIG. 1, the trusted devices 130a, 130b comprise Bluetooth low-energy transmitters, which periodically transmit the Bluetooth radio signals 132a, 132b, which comprise the authentication data packet 170a, 170b encoded therein.

The Bluetooth radio signals 132a, 132b can be a single Bluetooth packet, or a sequence of multiple packets, e.g. when the payload size of a single Bluetooth packet is insufficient. The interval between repeated Bluetooth transmissions is generally lower than that of the authentication data packet creation, such that the same authentication data packet 170a, 170b may be transmitted several times before the authentication data packet 170a, 170b changes. The Bluetooth radio signal 132a, 132b may be transmitted every 10-2000 ms, e.g. every 100-1000 ms or every 300 ms, 600 ms or 900 ms. In principle, even shorter or longer intervals could be chosen, such as every 1 ms or every 10 s.

The authentication data packet 170a, 170b made available by the trusted device 130a, 130b contains a code which is unique for each trusted device, such that an authentication data packet 170a is associated with the trusted device 130a, and authentication data packet 170b is associated with the trusted device 130b. Furthermore, the code periodically changes based on the current time, if the sequence is time based, as is described in detail later. Instead of using the time for changing to the next element in the sequence of numbers, also another trigger can be used, e.g. the detection of a person in front of the trusted device, a read-out of the authentication data packet etc.

Ideally, each trusted device 130a, 130b is unique for each floor 116a, 116b, such that each authentication data packet 170a, 170b is associated with a specific floor 116a, 116b. In case multiple elevators are arranged next to each other, each trusted device might also be unique for each elevator on each floor.

The Bluetooth radio signals 132a, 132b have a low transmission power, such that they can be received by a mobile device 140 only when the mobile device 140 is in vicinity of one of the trusted devices 130a, 130b. Preferably, the transmission power is chosen such that the mobile device 140 can only receive the signal when it is closer than 20 m, closer than 10 m or closer than 5 m to the trusted device 130a, 130b. Ideally, the location of the trusted device 130a, 130b is chosen such that the Bluetooth radio signals 132a, 132b are blocked from reaching beyond the target floor 116a, 116b, such that there is no crosstalk between radio signals.

In the example of FIG. 1, mobile device 140 is in range and configured to receive the Bluetooth radio signal 132a from the trusted device 130a. Encoded within the Bluetooth radio signal 132a is the authentication data packet 170a, which is temporarily stored on the mobile device.

The user 142 then selects an option for the operation of the elevator installation, e.g. a target floor from a list of floors displayed on the mobile device, and possibly further available attributes, such as an option indicating that the user 142 will require additional space in the car for the transport of goods or accompanying passengers.

When the selection has been made, the mobile device 140 encodes the selection, together with the authentication data packet 170a, in a mobile request message 172 and sends the mobile request message 172 to a server 160. The authentication data packet 170a is a possibility of request authentication data 171. Another possible implementation is described below.

In this example, the internet 150 is used for the transfer of the mobile request message 172; accordingly, both the mobile device 140 and the server 160 are connected to the internet 150 via adequate interfaces. The mobile device 140 can, for example, use a WLAN connection to a local network, which provides access to the internet via a local gateway, or it can use a cellular network connection such as LTE or any other standard for data transmission. The mobile request message can be sent using any available transfer protocol.

When the server 160 receives the mobile request message 172, it verifies the mobile request message 172. For this, the server analyzes the authentication data packet 170a included in the mobile request message 172 and checks that the authentication data packet 170a has been issued by a known trusted device 130a, and that the authentication data packet 170a has been issued within a permissible time interval, e.g. within the last 10 minutes, 5 minutes, 1 minute or 10 s. The authentication data packet 170a comprises the information required by the server to perform the verification.

After the server 160 has verified the mobile request message 172, it transmits an instruction message 174 to the elevator controller 120. The instruction message 174 includes instructions for the operation of the elevator installation. The instruction message can correspond to the user request represented by the mobile request message 172, or it can be manipulated according to rules or procedures included in, or performed by the server 160, e.g. programs for optimization of car routes, prioritization of select users, rejection of select users and such. Several mobile request messages 172 may be received by the server 160 before an instruction message 174 is sent to the elevator controller 120.

In this example, the internet 150 is used for the transfer of the instruction message 174 to the elevator controller 120; accordingly, both the server 160 and the elevator controller 120 are connected to the internet 150 via adequate interfaces. Preferably, the server 160 and the elevator controller 120 use a secure protocol for the transmission of the instruction message 174, however, the instruction message 174 can also comprise a separate authentication data packet which allows the elevator controller 120 to verify the authenticity of the instruction message 174, such that an insecure connection can be used.

Lastly, the elevator controller 120 controls the operation of the elevator installation 110 according to the instruction or instructions comprised within the instruction message 174.

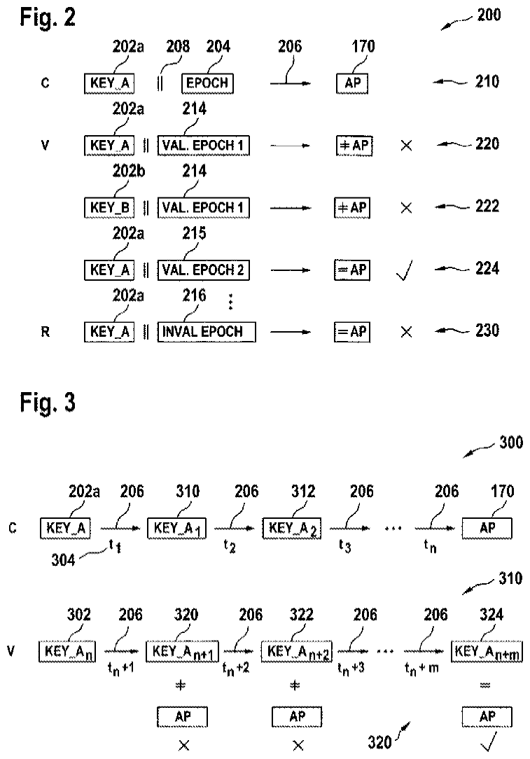

FIG. 2 shows a method 200 for creating and verifying an authentication data packet 170. This method is preferably performed by the trusted device 130a and the server 160. The procedure for other trusted devices, such as 130b, can be identical. In this embodiment, the trusted device 130a comprises a secret key 202a, herein denoted “KEY_A”. The trusted device further comprises a means for calculating an epoch 204, herein denoted “EPOCH”. The epoch 204 represents a time interval with a defined start time and an end time, i.e. a start time followed by a duration. The sequence of epochs 204 is thus an example of a predefined sequence of numbers. Each epoch 204 is an element of the sequence of numbers.

The epoch can be represented in various ways. In one example, the epoch can be a time code, such as a UTC time code or a Unix epoch. The epoch can also be represented by the number of epochs that have expired since an arbitrary starting epoch was defined. The expiration interval of each epoch is typically predefined and is known by the trusted device 130a and the server 160. The duration of an epoch can also be variable, as long as the procedure for epoch creation is known both by the server 160 and the trusted device 130a.

In step 210 (“C”), which is performed by the trusted device 130a, the key 202a is concatenated with the epoch 204. The concatenation function is represented by symbol 208 (“∥”). The concatenation or a representative subset thereof is then hashed by function 206 to form the authentication data packet 170, herein denoted “AP”. The authentication data packet 170 may be truncated after hashing.

Function 206 can be any suitable hash function. Function 206 preferably is a cryptographic hash function, i.e. a hash function that does not allow, without significant effort, the reconstruction of the key 202a from the authentication data packet 170. Examples for suitable hashing functions are SHA-2, SHA-3, RIPMED-160, Whirlpool and such. Function 206 can also be an encryption function, preferably using key 202a as encryption key, or any other key known to both the trusted device 130a and the server 160.

After the authentication data packet 170 has been received by the server 160, the verification (“V”) according to steps 220-222-224 is performed by the server 160.

The server 160 comprises a list of valid keys 202a, 220b (“KEY_A, KEY_B”) associated with valid trusted devices 130a, 130b. The server can calculate, look up or otherwise obtain the currently valid epochs 214, 215 (“VAL. EPOCH 1, VAL. EPOCH 2”), which represent time intervals for which authentication data packets as created by any trusted device, or a specific trusted device, such as trusted device 130a, are valid. Preferably, the valid epochs 214, 215 represent a limited number of epochs in the recent past, e.g. the two most-recent adjacent 30 s long epochs, which would typically correspond to authentication data packets created up to 60 s before they were received by the server.

To verify authentication data packet 170, the server 160 concatenates known valid keys 202a, 202b with valid epochs 214, 215, and performs function 206 on each combination of key and epoch. Each result is compared with the authentication data packet 170 as received. In the given example, the result of step 224 is identical to the authentication data packet 170, and the server 160 concludes that the authentication data packet has been created with the key 202a of trusted device 130a within valid epoch 215. The server has thus verified the authentication data packet and can perform the next steps as described in FIG. 1.

After the authentication data packet 170 has been verified, further verification of other combinations of key 202a, 202b and epoch 214, 215 can be omitted. If no valid combination of key and epoch are found, further steps according to step 230 (“R”) can be performed by the server. Here, invalid or expired epochs 216 are tried similar to steps 220-224. Even when a result is obtained that corresponds to authentication data packet 170, the authentication data packet 170 will be rejected, since the epoch 216 has expired.

The active search for expired authentication data packets provides a benefit in that it is possible to identify if a replay attack is ongoing, e.g. when long expired authentication data packets are used, or if, in case no match even for long expired epochs has been found, an untrusted device is trying to create authentication data packets with an untrusted key.

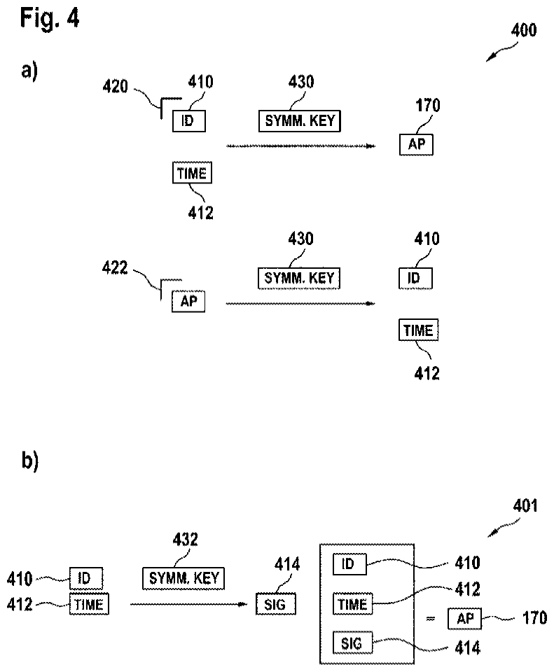

FIG. 3 shows an alternative method 300 for creating and verifying an authentication data packet 170, similar to method 200. Only the relevant differences to method 200 shall be discussed.

The trusted device 130a creates an authentication data packet 170 in step 310 (“C”), however, instead of performing a concatenation 208 of key 202a (“KEY_A”), with the current epoch, the trusted device 130a instead builds a hash chain based on the key 202a, by successively performing function 206 on the key 202a, or the result of the previous function 310, 312 (“KEY_A1, KEY_A2, . . . ”).

The function 206 is performed according to the number of time intervals 304 (“t₁, t₂, t₃, . . . , tₙ”) between the time of initialization of the trusted device 130a and the current time, thereby relating the number of iterations to the number of expired epochs since initialization. Initialization herein represents an arbitrary point in time, which may or may not correspond to the initialization time of the trusted device 130a. The initialization date is known to both the trusted device 130a and the server 160, and may be separately synchronized between the server 160 and each trusted device 130a, 130b, or may be common to all trusted devices 130a, 130b and the server 160. The length of each time interval 304 is typically predefined and is known by the trusted device 130a and the server 160. The length of each time interval can also be variable, as long as the procedure for time interval variation are known both by the server 160 and the trusted device 130a.

After the authentication data packet 170 has been received by the server 160, the verification (“V”) according to step 320 is performed by the server 160. For this, the server subsequently performs the function 206 on a verification starting key 302 (“KEY An”) or the resultant keys 320, 322 (“KEY_Aₙ₊₁, KEY_Aₙ₊₂, . . . ”) until it finds a result key 324 (“KEY_Aₙ₊ₘ”) which matches the authentication data packet 170. According to the number of keys known to the server 160, a large number of hash chain searches as described above may need to be performed.

The starting key 302 preferably is chosen such that the number of time intervals 206 (“tₙ₊₁, tₙ₊₂, tₙ₊₃, . . . , tₙ₊ₘ”) between the current time and the starting key 302 corresponds to a number of valid epochs as described for method 200. This reduces the number of calculations required by the server 160, since it can be concluded that, when a matching result is found, that the authentication data packet 170 has been produced within a valid epoch. Additionally, the expected authentication data packets may be pre-calculated, and may be stored in a lookup-table or database. A certain desynchronization between the server 160 and the trusted device 130a may occur, which might be compensated for by also allowing epochs that lie in the future, e.g. the next 1-5 minutes. Automatic adjustment for time drift may be performed by the server 160.

In order to identify expired authentication data packets according to method step 230, the starting key 302 may also be the key 202a at initialization, or any key created between initialization and the key corresponding to the current time or an arbitrary future time.

The hash-based authentication data packet creation and verification as described for FIGS. 2 and 3 has the benefit of only requiring a small amount of data to be transmitted from the trusted device 130a, 130b to the mobile device 140 and the server 160, since the result of the hashing function 206 can be truncated without a significant loss in security, e.g. to a length of 20 bytes, which would allow the authentication data packet to be sent in a single Bluetooth Low Energy packet according to Bluetooth 4.0 specification.

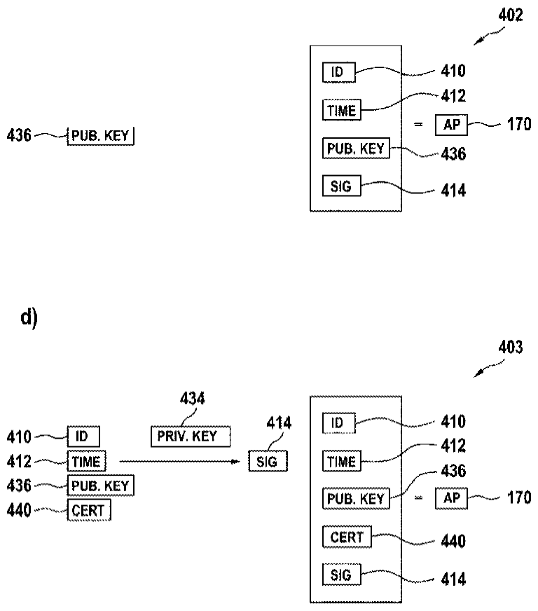

FIG. 4a)-d) shows further alternative methods 400-403 for creating and verifying an authentication data packet 170. The various embodiments of FIG. 4a)-d) comprise identical or similar features or functions, such that in the following, only differences between the respective embodiments shall be described.

In FIG. 4a), method 400 is presented, which comprises method step 420 for the creation of the authentication data packet 170, executed by a creation entity (preferably executed by trusted device 130a, 130b), and verification step 422, executed by a verification entity (preferably executed by server 160). Both the creation entity and the verification entity have knowledge of a symmetric key 430.

At step 420, a unique identifier 410 (“ID”) and a timestamp 412 (“TIME”) are prepared, e.g. by creating a serialized representation of the two values, e.g. by encoding the values in a markup language such as XML or JSON. The unique identifier 410 can be any value unique to the creating device, such as a random number, a MAC-address or a UUID. The timestamp 412 can be any value representing the time, wherein the time can be a real time in any known encoding, an epoch, a counter or such. The timestamp, or more precisely the series of timestamps, is as already mentioned above for the epoch, an example of a predefined sequence of numbers. Each timestamp is an element of the predefined sequence of numbers. The timestamp can further comprise an expiration indicator, e.g. a second timestamp, which indicates the time by which the authentication data packet 170 expires. By including an expiration indicator, the expiration time can be variably chosen for each trusted device 130a, 130b, which allows the trusted devices 130a, 130b to be better adaptable to the specific requirements of the elevator system 100.

The prepared values 410, 412 are then encrypted by the creation entity, e.g. by the trusted device 130a, 130b, by utilizing a symmetric encryption algorithm together with symmetric key 430. The encrypted values representing the values 410, 412 are comprised by the authentication data packet 170. Any symmetric encryption algorithm, such as AES, Triple-DES, Blowfish and such can be used.

At step 422, the decryption is performed by the verification entity, e.g. by the server 160 after having received the authentication data packet 170, by reversing the encryption according to the symmetric encryption algorithm with the symmetric key 430. After decryption, both the unique identifier 410, as well as the timestamp 412 are available to the verification entity, such that the verification entity can verify if the authentication data packet 170 is valid. The verification entity might comprise a list of several symmetric keys 430 associated with different creation entities, and, if no further knowledge of the creation entity is available, try different keys from the list of keys until a successful decryption could be performed.

Since the encryption and decryption are only possible with symmetric key 430, no third-party attacks are possible as long as symmetric key 430 is not compromised.

In FIG. 4b), method 401 is presented, which shows an advancement to method 400. Instead of forming the authentication data packet 170 from the encrypted values representing the values 410, 412, a cryptographic signature 414 (“SIG”) is calculated from the unique identifier 410 and the timestamp 412 with symmetric signing key 432 by the creation entity. The cryptographic signature may be similar to the encrypted values representing the values 410, 412 of method 400 and calculated by the same algorithms. For reasons of practicality, the signature 414 may then also be truncated or otherwise shortened to a practical length after encryption, such that the encryption or signing function cannot be reversed, but so that the signature 414 can still be used and verified as a cryptographic signature or cryptographic fingerprint. Other cryptographic algorithms than that used for the symmetric encryption described for method 400 may be used. In particular, algorithms particularly suitable for symmetric signature creation may be used.

The authentication data packet is then assembled from the cleartext unique identifier 410, the cleartext timestamp 412 and the cryptographic signature 414.

For verification (not shown) by the verification entity, preferably by the server 160 after having received the authentication data packet 170, the cleartext unique identifier 410 and the cleartext timestamp 412 can first be checked.

If both values are valid, the signature can then be checked by performing the same signing calculation as the creation entity, as described above. Ideally, the verification entity can associate the symmetric signing key 432 to the unique identifier 410 included in the authentication data packet 170. This allows the verification entity to store several symmetric signing keys 432, e.g. one or more possible keys associated with every unique identifier 410.

If the calculation by the verification entity with a key known to be associated with the creation entity results in the same value as signature 414, the authentication data packet is valid.

Instead of a symmetric signing key 432, an asymmetric keypair can be used together with an asymmetric signing algorithm (not shown, for possible algorithms, see method 402, FIG. 4c), wherein the signing is performed with a private key known to the signing entity, and the verification can be performed with a corresponding public key 436 known to the verifying entity. The public key 436 can serve as a unique identifier 410.

The method of FIG. 4b) has the advantage that the unique identifier 410 and the timestamp 412 are included in the authentication data packet in cleartext form. Hence, invalid or expired authentication data packets can be recognized and/or rejected, e.g. by the mobile device or the server, without knowing how to perform the verification, or before verification is attempted.

In FIG. 4c), method 402 is presented, which shows an advancement to method 401. In addition to the unique identifier 410 and the timestamp 412, a public key 436 (“PUB. KEY”), known to both the signing entity and the verification entity, is included in the cleartext portion of the authentication data packet 170. The public key 436 can replace the unique identifier 410. The cleartext portion is signed with the private key 434 (“PRIV. KEY”), known to the signing entity, to form signature 414. The cleartext portion, together with signature 414, comprises the authentication data packet 170. The public key 436 corresponds to the private key 434 used for signing the cleartext portion.

Any method for performing public key cryptography, also known as asymmetric cryptography, suitable for creating a cryptographic signature can be used. Known algorithms include RSA, DSA, the Rabin signature algorithm and various others.

Method 402 has the benefit that any intermediate entity, such as the mobile device 140, can perform a partial verification of the authentication data packet 170 with the public key 436 included therein. This allows the intermediate entity to verify the data integrity of the authentication data packet, and to recognize forgeries.

Another benefit is the fact that only the creation entity, e.g. the trusted device 130a, 130b needs to know the private key. The verification entity can fully verify the authentication data packet 170 by knowing if private key 434 corresponds to a known trusted device. Hence, even if the server is compromised and the list of public keys is obtained by a potential attacker, the signature of the signing device cannot be forged.

In FIG. 4d), method 403 is presented, which shows an advancement to method 402. In addition to the unique identifier 410, the timestamp 412 and the public key 436, a certificate 440 (“CERT”) is included in the cleartext portion of the authentication data packet 170. The creation of the authentication data packet 170 and the verification is then performed according to method 402.

The certificate 440 provides a way for independently verifying the public key 436 included within the cleartext portion of the authentication data packet 170. Based on the verification of the public key 436, a verification entity or an intermediate entity can conclude if the creation entity is a known creation entity, e.g. a trusted device 130a, 130b. If the certificate is invalid, it can be further concluded that the authentication data packet is invalid. The certificate 440 can replace the unique identifier 410.

The certificate 440 can comprise a signature of the public key 436, as obtained by using an asymmetric signing algorithm as described herein. The certificate is preferably created by a certificate authority (not shown), which comprises a private key only known to the certificate authority. The public key of the certificate authority is ideally available to any device, or can be requested from and provided by the certificate authority.

Additionally, the certificate authority can revoke certificates, e.g. when a private key 434 has been lost or compromised. The certificate can be issued, verified, revoked, stored, distribute or registered according to any method for implementing a public key infra-structure.

The use of a certificate allows the verification entity or any intermediate entity to verify any authentication data packet created by any creation entity by first verifying if the certificate is valid.

In one simplified example, a single private certificate key, known to the certificate authority, is used to sign the certificates of all creation entities. The corresponding public certificate key is known to the verification entity. The verification entity can then, without knowing the public key 436 of the creation entity, verify the authentication data packet by first verifying the public key 436 by verifying if the certificate 440 corresponds to the public key 436 as signed with the private certificate key. If the public key 436 is valid, the unique identifier 410 and the timestamp 412 are checked with the verified public key 436 as described above.

This has the benefit of not requiring the verification entity to have access to a list of known creation entities, while still allowing the verification of valid authentication data packets.

In the following a variation of the above described elevator system will be explained, also with reference to FIG. 1. Only the differences are described.

In this example the trusted devices 130a, 130b use for example near field communication technology, in short NFC, for transmitting data from the trusted device 130a, 130b to the mobile device 140, however any other technology for transferring data from the trusted device 130a, 130b to the mobile device 140 could be used. Each of trusted devices 130a, 130b of this example use, instead of a predefined sequence of numbers based on the time, e.g. the above described epoch, a counter for generating the sequence of numbers. The counter is increased by one each time the mobile device 140 reads out the authentication data packet 170a, 170b from the respective trusted device 130a, 130b. The current counter value is used as the element of the predefined sequence of numbers on which the unique, periodically changing code is based on. Thus, the predefined sequence of numbers are the natural numbers for example. The period of the periodically changing code is thus not a constant duration. It is defined by two subsequent read-outs of the NFC signal.

The element of the sequence is protected against manipulation during transmission from the trusted device 130a, 130b to the server 160 by the various methods described above with respect the trusted device 130a using the time as the predefined sequence of numbers or a time-related number such as the epoch or timestamp.

Further, to protect the elevator system against various attacks such as replay attacks, the server 160 keeps track of the received elements of the predefined sequence of numbers. The simplest system stores the received elements of the sequence of predefined numbers and only allow elements which have not yet been received.

Various improvements or variations are possible. For example, similar as with the timestamp discussed above and the associated validity period of the timestamp, only an element in a certain range around the last received element within the sequence of numbers is accepted as a valid element. Another possibility is to only accept an element which is in the sequence of number after the last received element as a valid element.

In case of increasing the counter each time by one, this can be done by checking if the element, which is a natural number, is bigger than the last accepted element. Thus, the server 160 need only to store the last received element which was valid for keeping track of the predefined sequence of numbers on the server 160.

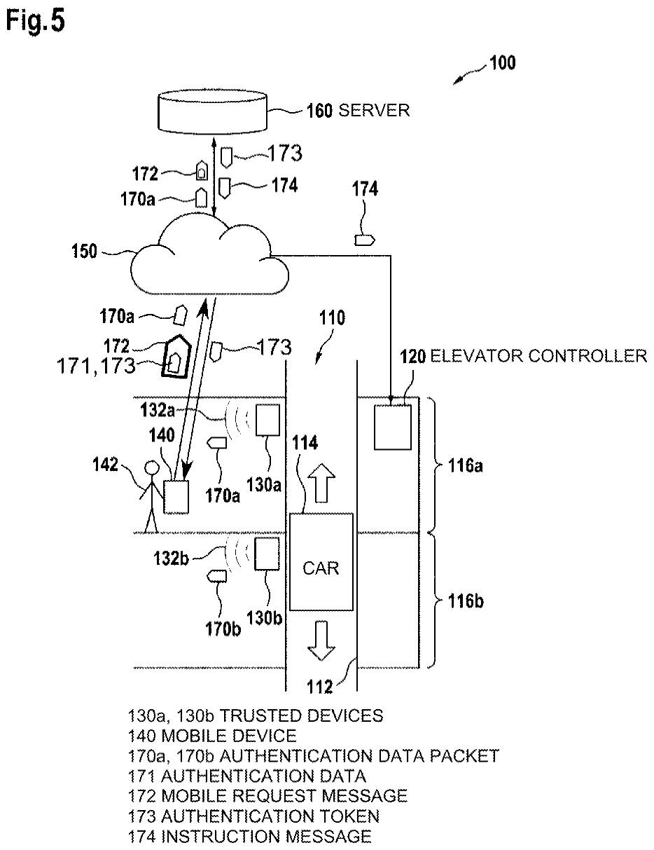

FIG. 5 shows a variation of the elevator system shown in FIG. 1 and the variation of the elevator systems described above. In the following, only the differences are described.

Instead of sending the authentication data packet 170a as part of the mobile request message 172 as described above with reference to FIG. 1, it is also possible to forward the authentication data packet 170a essentially directly or immediately after the mobile device 140 has received the authentication data packet 170a to the server 160.

For example, the authentication data packet 170a could be part of a link, which is transmitted from the trusted device 130a to the mobile device 140. The mobile device 140 uses a web browser application to open the received link and by opening the link also the authentication data packet 170a is sent to the server 160. Typically, the server's internet address is contained in the link.

The server 160 checks the authentication data packet 170a for validity as described above with respect to FIGS. 1 to 4. If the authentication data packet 170a is valid, the server 160 sends an authentication token 173 back to the mobile device 140, for example together with a web interface for requesting elevator service.

As the authentication data packet 170a is directly or immediately after the mobile device 140 has received the authentication data packet 170a sent to the server 160, the validity period can be made quite short, for example several seconds or minutes. In case the predefined sequence of numbers is implemented by a counter as described above, this can be implemented by requiring that only numbers are accepted, which are bigger than the last accepted number.

The user of the mobile device 140 can select a target floor or destination on the web page displayed on his mobile device 140, which sends back the mobile request message 172 including the request for operation of the elevator system 100. The authentication token 173 is also sent to the server 160 as part of the mobile request message 172. The authentication token 173 forms in this example the request authentication data 171.

The server 160 checks the validity of the authentication token 173 and in case the token 173 is valid sends the instruction message 174 to the elevator controller 120. The authentication token might only be valid during a certain time period.

The system and methods described herein increase the security of elevator systems by providing a method for verifying an authentication data packet not only based on a verifiable identity, but also on a verifiable time component included in the authentication data packet. By implementing the described method, a valid request for the operation of an elevator system can only be made when the user is currently in the vicinity of a trusted device, thereby hindering malicious third parties from performing denial of service attacks from remote locations.

Furthermore, the system and methods described herein can be implemented without requiring additional modifications to the mobile device, thereby increasing security without diminishing the user experience.

In accordance with the provisions of the patent statutes, the present invention has been described in what is considered to represent its preferred embodiment. However, it should be noted that the invention can be practiced otherwise than as specifically illustrated and described without departing from its spirit or scope.

1-19. (canceled)

20. A method for operating an elevator system using a mobile device, the elevator system including an elevator controller and a fixedly installed trusted device, wherein the trusted device is a physical unit fixedly installed in a vicinity of an elevator landing of the elevator system, the method comprising the steps of:
operating the trusted device to create an authentication data packet, the authentication data packet including a unique, periodically changing code based on an element of a predefined sequence of numbers;
the trusted device makes the authentication data packet available to be received;
the mobile device receives the authentication data packet;
the mobile device obtains a request for operation of the elevator system;
the mobile device sends a mobile request message to a server, wherein the mobile request message includes the request for operation of the elevator system and request authentication data;
the server verifies authenticity of the mobile request message based on the request authentication data included in the mobile request message, wherein the request authentication data is one of the authentication data packet and an authentication token received from the server after the authentication data packet is sent to the server and the server has verified the authentication data packet; and
the server, after the request authentication data has been verified, sends an instruction message to the elevator controller, wherein the instruction message includes an instruction to operate the elevator system according to the request for operation of the elevator system.

21. The method according to claim 20 wherein the sequence of numbers is a monotonic sequence of numbers, preferably a strict monotonic sequence.

22. The method according to claim 21 wherein the monotonic sequence of numbers is a strict monotonic sequence.

23. The method according to claim 20 wherein the sequence of numbers is based on time and the element is a current time.

24. The method according to claim 20 wherein the unique, periodically changing code is formed by the element signed by a digital signature.

25. The method according to claim 20 wherein the unique, periodically changing code is formed by the element encrypted by a symmetric encryption algorithm.

26. The method according to claim 20 wherein the trusted device includes a display, and the trusted device makes available the authentication data packet by generating a QR-code from the authentication data packet and displaying the QR-code on the display.

27. The method according to claim 20 wherein the trusted device includes a low-power radio frequency transmitter that makes the authentication data packet available, and wherein a power of the transmitter is such that a range in which a transmission from the transmitter can be reliably received by the mobile device is limited to a range of up to 100 meters from the trusted device.

28. The method according to claim 20 wherein the trusted device periodically creates a new unique, periodically changing code that replaces the previous unique, periodically changing code.

29. The method according to claim 28 wherein the trusted device creates the new unique, periodically changing code within an interval of 0.01 minute to 10 minutes.

30. The method according to claims 20 wherein the trusted device periodically creates a new unique, periodically changing code each time the code is read from the trusted device by the mobile device.

31. The method according to claim 20 wherein the trusted device includes near field communication technology for transmitting the unique, periodically changing code from the trusted device to the mobile device.

32. The method according to claim 20 wherein the authentication data packet includes an expiration indicator representing a time by which the authentication data packet becomes invalid.

33. The method according to claim 20 wherein the mobile device is not paired with the trusted device.

34. The method according to claim 20 wherein the method is performed without any authentication between the mobile device and the server or between the mobile device and the trusted device.

35. The method according to claim 20 wherein the request for operation of the elevator system includes a target floor.

36. The method according to claim 20 wherein the elevator system includes at least two of the trusted device, and wherein the authentication data packet transmitted by each of the trusted devices is specific to an associated landing of the elevator system.

37. The method according to claim 20 wherein the mobile device receives a plurality of the authentication data packet, and including:
the mobile device records metadata about the authentication data packets;
the mobile device stores the authentication data packets and the metadata in a memory; and
the mobile device, after obtaining the request for operation of the elevator system, selects one of the authentication data packets from the plurality of authentication data packets stored in the memory based on the metadata stored in the memory.

38. A system for operating an elevator installation, the system including an elevator controller, a fixedly installed trusted device, at least one mobile device and a server, wherein the trusted device is a physical unit fixedly installed in a vicinity of an elevator landing of the elevator installation, the system comprising:
wherein the trusted device is adapted to periodically create at least one authentication data packet, the at least one authentication data packet including a unique, periodically changing code based on an element of a predefined sequence of numbers, and wherein a most recently created one of the at least one authentication data packet is a current authentication data packet;
wherein the trusted device is adapted to periodically make the current authentication data packet available to be received by the at least one mobile device, the at least one mobile device being adapted to receive the current authentication data packet, and wherein the at least one mobile device, after having received the current authentication data packet, is a current mobile device;
wherein the current mobile device is adapted to send a mobile request message to the server after having received the request for operation of the elevator installation, wherein the mobile request message includes the request for operation of the elevator installation and a request authentication data, wherein the request authentication data is the current authentication data packet or an authentication token received from the server after having sent the current authentication data packet to the server and the server has verified the current authentication data packet;
wherein the server is adapted to receive the mobile request message from the current mobile device;
wherein the server is adapted to verify the mobile request message based on the request authentication data included in the mobile request message; and
wherein the server, after the mobile request message has been verified, is adapted to send an instruction message to the elevator controller, the elevator controller being adapted to receive the instruction message, wherein the instruction message includes an instruction to operate the elevator installation according to the request for operation of the elevator installation.

39. A trusted device for use in an elevator system, the trusted device comprising:
a physical unit adapted to be fixedly installed in a vicinity of an elevator landing of the elevator system;
wherein the trusted device creates an authentication data packet, the authentication data packet including a unique, periodically changing code based on an element of a predefined sequence of numbers; and
wherein the trusted device makes the authentication data packet available to be received by a mobile device being used to send a mobile request message to a server of the elevator system, wherein the mobile request message includes a request for operation of the elevator system and request authentication data.
